(19) United States
(12) Patent Application Publication
(10) Pub. No.: US 2026/0015045 A1
(43) Pub. Date: Jan. 15, 2026

(54) DOOR RING FOR A MOTOR VEHICLE BODY

(71) Applicant: BENTELER AUTOMOBILTECHNIK GMBH, Paderborn (DE)

(72) Inventors: Georg FROST, Steinheim (DE); Rainer LAPSIEN, Bueren-Wewelsburg (DE)

(21) Appl. No.: 19/262,099

(22) Filed: Jul. 8, 2025

(30) Foreign Application Priority Data
Jul. 9, 2024 (EP) 24187307.4

(51) Int. Cl. B62D 29/00; B23K 26/244; B23K 26/322; B23K 101/00; B23K 101/34; B23K 103/04; B62D 25/02; B62D 25/04; B62D 25/06; B62D 27/02

(52) U.S. Cl. CPC B62D 29/007; B23K 26/244; B23K 26/322; B62D 25/025; B62D 25/04; B62D 25/06; B62D 27/023; B23K 2101/006; B23K 2101/34; B23K 2103/04

(57) ABSTRACT

A door ring for a motor vehicle body, including individual components coupled to one another in the form of an A-pillar, a B-pillar, a roof frame part and a sill part. At least in one region a tensile strength Rm greater than 1300 MPa is formed and in another region a tensile strength Rm less than 1000 MPa is formed. The door ring has a corrosion protection layer, and the components are laser-welded with an overlap, and the corrosion protection layer is formed between the overlapping layers.

### RELATED APPLICATIONS

The present application claims priority of European Application Number 24187307.4 filed Jul. 9, 2024, the disclosure of which is hereby incorporated by reference herein in its entirety.

### FIELD

The present disclosure relates to a door ring for a motor vehicle body.

### BACKGROUND

Motor vehicle bodies are manufactured as self-supporting bodies. Such vehicles are powered by combustion engines, but also by electric motors.

A self-supporting motor vehicle body has individual body components, for example A-pillar, B-pillar, C-pillar, a motor vehicle sill, various cross and longitudinal members, a window frame, a roof frame, a roof as well as various floor sheet metals and other attachments.

For this purpose, individual components are processed using forming technology and then joined together, for example, by welding. This creates a self-supporting vehicle body.

A door ring is for accommodating a motor vehicle door, and is able to be a prefabricated component.

Such a door ring has an A-pillar in the front region and a B-pillar in the rear or middle region between the driver's door and behind the driver's door. In the roof region, the A-pillar merges into at least part of the roof frame. In the lower region there is a so-called sill. Overall, this creates a circumferential ring through which a passenger is able to enter the future vehicle body. This ring will later be closed by a vehicle door.

In cross-section, these are able to be shell components that are coupled with additional strike plate(s) or similar. However, the door ring is initially a blank component and is able to be designed as a single shell in various embodiments. As already mentioned, additional strike plates may be added later during body construction.

### SUMMARY

The object of the present disclosure is to provide a door ring which provides improved strength properties, improved corrosion protection properties and, at the same time, more cost-effective manufacturability.

The aforementioned object is achieved with a door ring.

The door ring for a motor vehicle body has individual components coupled together, in the form of an A-pillar, a B-pillar, a roof frame part and a sill part. The door ring is also able to be a double door ring. In the longitudinal direction of the motor vehicle, the door behind the driver's door and the passenger door are also included. The door ring would then have another part of the roof frame running in the longitudinal direction of the vehicle, a C-pillar, a rear sill part and, if applicable, parts of a wheel arch or wheel house located behind.

This door ring is able to initially be seen in cross-section as a single-shell component. Additional components, strike plate(s) or similar are able to be added.

At least in sections, the door ring is characterized in that the door ring has a strength, for example, tensile strength Rm, of at least individual components greater than 1300 MPa, greater than 1500 MPa, and greater than 1800 MPa. However, the tensile strength Rm should not exceed 2200 MPa. This is made possible by using hardened steel for at least one of the interconnected components of the door ring. The steel is able to either be an ultra-high-strength steel produced by a cold forming process. However, the steel is also able to be a hardenable steel, for example, a manganese-boron steel, which is formed by hot forming and press hardening. The component then exhibits, at least in some regions, the tensile strengths described above in hard or strong regions. Each region is formed by a component. A component is therefore understood to be an A-pillar (or roof frame), a B-pillar, a sill. The individual components are made of different steel grades. Individual components are able to be made from hardenable manganese-boron steels. Other components are able to be made from other steel grades. The components are provided with a corrosion protection layer and laser welded together, as described below.

This means that the individual components are first manufactured separately from one another. In at least one embodiment of the present disclosure, individual components are manufactured by hot forming and press hardening with the tensile strengths described above. Each component is then transformed into a three-dimensional shell component. Some or all components of the door ring are pre-coated before they are individually manufactured or formed. For this purpose, the steel strip material of individual or all components are able to have Al-based and/or Zn-based pre-coatings. AlSi pre-coatings are for steel materials, which are then hot-formed and press-hardened into individual components. During heating in the hot forming process, the AlSi pre-coating is transformed into a stable corrosion protection layer, namely on an AlSiFe basis. A Zn-based pre-coating is converted into a ZnFe-based corrosion protection layer during hot forming.

Alternatively or additionally, some or all components are provided with a corrosion protection layer after forming and only then joined together.

After joining, a further corrosion protection layer, for example, a cathodic dip coating, is able to be applied as part of the body painting process with several layers of paint.

Performing a laser welding only after the components have been formed offers provides that material is able to be saved, with regard to component waste, since blanks for forming the individual components are able to first be prepared with little waste and then formed into the individual component. After the three-dimensional forming has taken place, the individual components are then completed to form the door ring according to the present disclosure, i.e., the individual components are placed together and then welded together.

Where complete hardening is intended for maximum tensile strength, the upper region of the B-pillar (including roof frame stub) and the upper regions of the A-pillar and roof frame, a press-hardenable steel alloy (steel A to D) is used, while regions or components that act as deformation zones in the event of a side impact, such as the sill, the lower base region of the B-pillar and the sill stub or the lower part of the A-pillar, are made of non-hardenable or hardly hardenable steel (steel E or F) with a tensile strength below 1000 MPa (e.g., 500 to 800 MPa). The chemical analyses of the individual steel alloys (steel A to F) which are able to be used according to the present disclosure according to the following table contain data in mass percent and show the remainder as iron and impurities which are unavoidable during melting. For reinforcement patches or reinforcement sheet metal on the A-pillar and B-pillar, one of the steels A to D is able to also be used, with steel C or D, as in this case a tensile strength above 1900 MPa is able to be achieved after press hardening, while steels A and B have a tensile strength just above 1400 MPa after press hardening.

The door ring then has further regions or coupled components that have a tensile strength Rm of less than 1000 MPa, or less than 850 MPa. However, the tensile strength Rm should be at least 350 MPa, or at least 500 MPa, even in these relatively softer regions.

Furthermore, the door ring or the steel components have a corrosion protection layer, which has the same coating on all components coupled to the door ring, including the same layer thickness and specific layer weight. Alternatively, the sills and B-pillar base are able to have a higher quality, thicker and/or heavier corrosion protection layer than the A-pillar, roof frame or upper B-pillar.

According to the present disclosure, at least two of the individual components are laser-welded to one another with a lap joint, at least in individual regions with a lap joint. According to the present disclosure, the corrosion protection layer is also formed between the overlapping layers. The overlap or lap joint allow for the components to initially be joined together easily and efficiently, while compensating for any component tolerances. The overlap compensates for differences in length.

According to the present disclosure, at least two components are then welded together in at least one region by means of overlapping and laser welding.

Different strengths are able to be set. Alternatively or additionally, different wall thicknesses are able to be used in the regions of different strength in order to also produce different stiffness properties of the door ring.

On the hot-formed component, the corrosion protection layer is formed on an aluminum-silicon-iron basis. Such a corrosion protection layer is used for a component that is to be hot-formed and press-hardened. The components are thus pre-coated. The AlSi coating is able to have a layer thickness of 10 μm to 45 μm, but a relatively low layer weight of 20 g/m² to 90 g/m² per sheet side and/or a layer thickness of 10 μm to 25 μm is formed in order to reduce the negative influence of the aluminum and intermetallic phases on the welded joint. If the component is heated above the austenitizing temperature, i.e., above the Ac3 temperature, the pre-coating will alloy through. In the case of a cold-formed component, for example, a UHSS component, a zinc-based corrosion protection layer is able to be used.

The laser welding according to the present disclosure is carried out as laser remote welding. For this purpose, wire-free welds are formed at least along one line or joint region. Since, according to the present disclosure, the laser weld seams are only created after hot forming and press hardening of at least some of the components or joining partners, they are able to be identified on the finished door ring as a welding-related heat-affected zone by measuring the hardness profile transverse to the joint regions and are able to be distinguished from those welded joints that are already created at the level of not deformed sheet metal blanks and only subsequently undergo a hot forming process. In at least one embodiment of the present disclosure, the door ring has a characteristic discontinuous hardness profile in the joint region with a hardness peak and hardness dips sloping therefrom on both sides, which results from the heat input of the welding laser beam as a type of local small-area tempering. However, the hardness reduction, at least in the component or region made of hardenable steel, is less than 30% or less than 25% compared to press-hardened regions outside the heat-affected zone.

A wire-containing weld seam is able to be used to better compensate for gaps or tolerances, in radii or curved joint regions. Wire-containing refers to a welding filler material.

Alternatively or in addition to a wire-containing weld seam, an oscillating or rotating movement of the laser beam with or without gap-controlled increased melting power is able to be carried out.

The overlap region is formed from one component to the other component to be less than 25 mm, less than 20 mm, less than 15 mm, and less than 10 mm. However, the overlap region should be at least 2 mm, or 5 mm.

When two layers overlap, a weld is made which starts from the surface of one layer, then completely penetrates the upper layer and passes into the layer below. In such a case, a weld root is formed that is oriented perpendicular to the surface. This weld root penetrates less than 90%, less than 80% of the second layer. On the one hand, this has the advantage of ensuring that the two layers are well welded together in this region. A further advantage is that the corrosion protection layer on the underside of the second layer is not attacked by a weld seam that completely penetrates the second layer. This provides good corrosion protection on the back of the weld seam. Good corrosion protection properties are also provided in the region where the weld seam or weld root passes from the first layer to the second layer and where the corrosion protection layer is located between the layers.

According to the present disclosure, the upper side of the weld seam, depending on the corrosion protection layer used, melts or mixes with this corrosion protection layer and, at the same time, after completion of the laser welding process, the upper side of the weld seam is also protected against corrosion.

As an alternative to the previously described weld seam, which is perpendicular to the surface, would be provided that an oblique weld root is introduced. From an overlapping layer, the front side extends diagonally into the second layer after penetrating the first layer in cross-section. In at least one embodiment of the present disclosure, this takes place at an angle between 30° and 45°, and 20° to 50°.

One advantage here is that, since the front edge is sometimes free of coating material of the corrosion protection layer, there is less introduction of corrosion protection layer material into the weld seam itself. The quality of the weld seam is thus improved. After welding is complete, the top side of the weld seam is then able to be provided with a final corrosion protection layer. In addition, welding additives, wire, are able to be used in this type of weld seam design, which allows larger welding gaps to be bridged without the need for additional melting of the upper layer facing the laser beam during welding and/or the use of oscillating laser beams or adaptive power.

A further advantage of the laser welding process used is that the weld seam does not have to run parallel or transverse to the longitudinal axis of the two overlapping regions. In at least one embodiment of the present disclosure, this is able to follow the profile of a wave or zigzag line or be sawtooth-shaped. This improves the heat input into the component and the strength of the welded joint, as a relatively larger region is joined, which further improves the strength of the welded joint. Any resulting stresses and/or heat influences are better compensated in the material by a wave-shaped profile of the weld seam. In the event of a crash, local stress peaks and a load perpendicular to the weld seam are reduced or converted into a more oblique load.

In accordance with the present disclosure, a reinforcement patch is also able to be introduced. This is where a double layer is formed, for example, in the region of the A-pillar or the B-pillar, for example, in the region of door connection points or crash-prone regions. However, a reinforcement patch is also able to be inserted in the region of the sill, for example. The reinforcement patch is spot welded. The reinforcement patch is then able to be hot-formed and press-hardened, for example. Alternatively, in the case of a cold-formed component, the reinforcement patch later is able to be inserted, wherein the reinforcement patch itself is also formed separately.

The reinforcement patch is also able to be overlap two adjacent components, thus, the reinforcement patch is able to provide an additional reinforcement in the region of the joint between two components.

In at least one embodiment of the present disclosure, a triple layer is able to be welded through. Here, not only two adjacent components lie on top of each other, but three layers are formed in the cross-section. In this case too, less than 95%, less than 90%, and less than 80% of the wall thickness of the bottom layer are welded through. This in turn offers the advantage that the corrosion protection layer on the underside of the lowest layer is not disturbed.

### BRIEF DESCRIPTION OF THE DRAWINGS

Further advantages, features, properties, and aspects of the present disclosure are the subject of the following description. Various embodiments are shown in the schematic figures. These simplify the understanding of the present disclosure. In the figures:

FIG. 1 shows a door ring according to at least one embodiment of the present disclosure,

FIG. 2 shows a rear view of the variant shown in FIG. 1 according to at least one embodiment of the present disclosure,

FIG. 3 shows a detailed view of the B-pillar according to at least one embodiment of the present disclosure,

FIG. 4 shows another detailed view of the B-pillar according to at least one embodiment of the present disclosure,

FIG. 5 shows a further embodiment variant of a door ring according to the present disclosure,

FIG. 6 shows a connection region in cross-sectional view according to at least one embodiment of the present disclosure.

FIG. 7 shows a further embodiment variant of the weld seam produced by laser welding according to the present disclosure,

FIG. 8 shows a further embodiment variant of the present disclosure,

FIG. 9 shows a further embodiment variant of the weld seam produced by laser welding according to the present disclosure,

FIG. 10 shows a weld seam profile in its longitudinal direction according to the present disclosure,

FIG. 11 shows an alternative to FIG. 10 according to the present disclosure.

### DETAILED DESCRIPTION

In the figures, the same reference numerals are used for same or similar components, although a repeated description and illustration is omitted for reasons of simplicity.

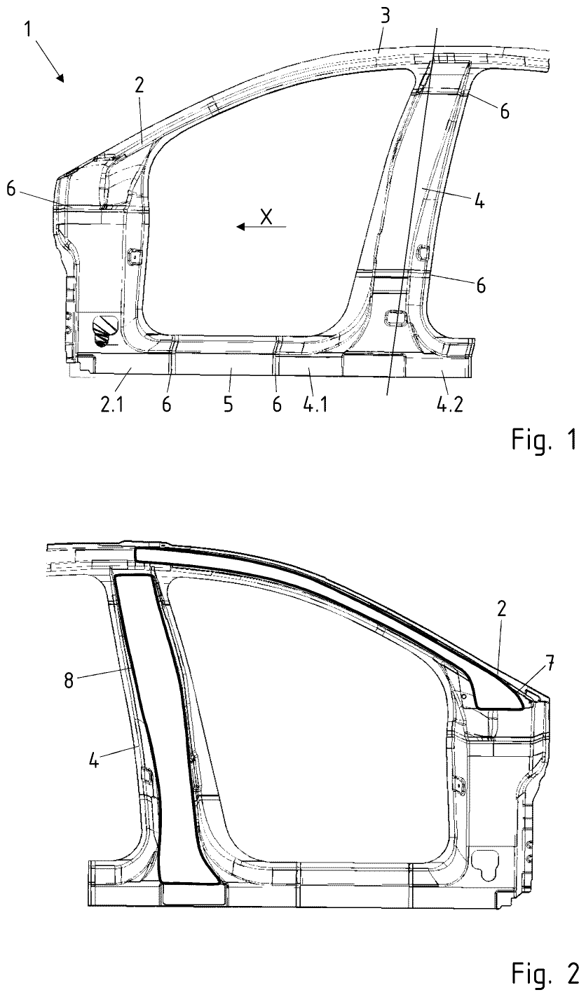

FIG. 1 shows a door ring 1. The door ring 1 has an A-pillar 2, part of a roof frame 3, a B-pillar 4 and part of a sill 5. This door ring 1 is able to initially be designed as a single-shell in cross-section. In the region of the A-pillar 2, in the region of the B-pillar 4, in the region of the roof frame 3 but also in the region of the sill 5, closing strike plates or closing half-shells or even an inner door ring made in one piece from a tailor-made welded sheet metal blank (TWB for short) is able to be applied, so that in the cross-section a height profile is created at least partially to completely. In at least one embodiment of the present disclosure, the single-shell layer is as shown in FIG. 1. The B-pillar base is able to, for example, be T-shaped, as shown here, so that a respective sill stub 4.1 or 4.2 is created. The same applies to the A-pillar 2, where a sill stub 2.1 is able to also result. The roof frame 3 is able to protrude rearward in the longitudinal direction X of the motor vehicle. Here, various connection regions 6 or overlap regions between the components are formed. For example, in the connection regions according to reference numeral 6, the individual components are either divided themselves and welded by means of an overlap. Otherwise, two adjacent components are welded together. For the purposes of this entire disclosure, the fact that the A-pillar 2 in this region and the roof frame 3 is able to be one component applies to the upper region of the A-pillar 2 and the roof frame 3. Thus, the A-pillar 2 extends to the B-pillar 4. However, the A-pillar 2 and roof frame 3 are also able to be two components that are welded together, as shown in FIG. 1.

FIG. 2 shows a rear view of the variant shown in FIG. 1. Here a reinforcement patch 7 is attached from the rear inner side in the region of the A-pillar 2. This reinforcement patch 7 is welded over a large part to the A-pillar 2. Furthermore, a reinforcement patch 8 is attached to the rear or in the B-pillar 4.

While the reinforcement patch 7 of the A-pillar was press-formed, or press-hardened, together with the A-pillar itself in a forming step, the reinforcement patch 8 of the B-pillar is also able to have been inserted after the forming. This is the case if, as shown, is designed and arranged to extend into the T-shaped B-pillar base, so as to project beyond the weld seam in the connection region 6.

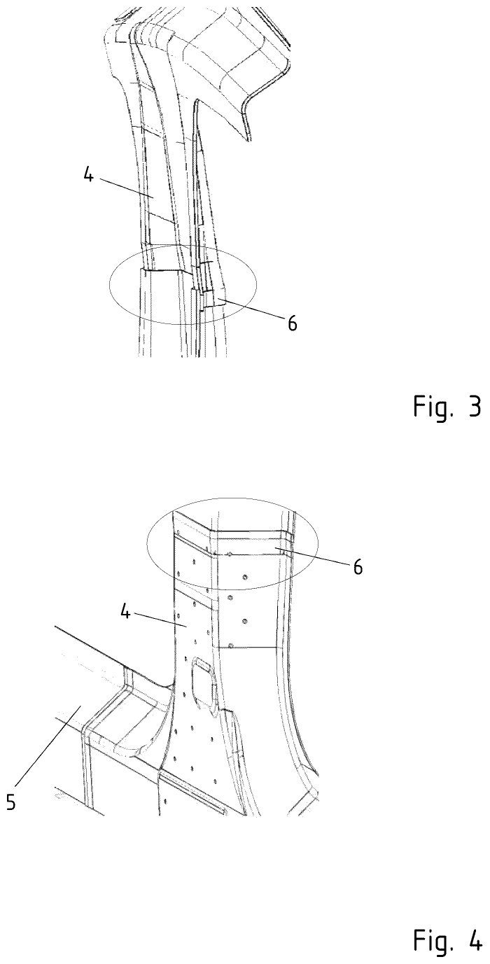

FIG. 3 and FIG. 4 each show a detailed view of B-pillar 4. Here, an overlap is shown, which will be discussed further below. In at least one embodiment of the present disclosure, further spot welds are shown in FIG. 4. These are able to be used for coupling with the reinforcement patch 8.

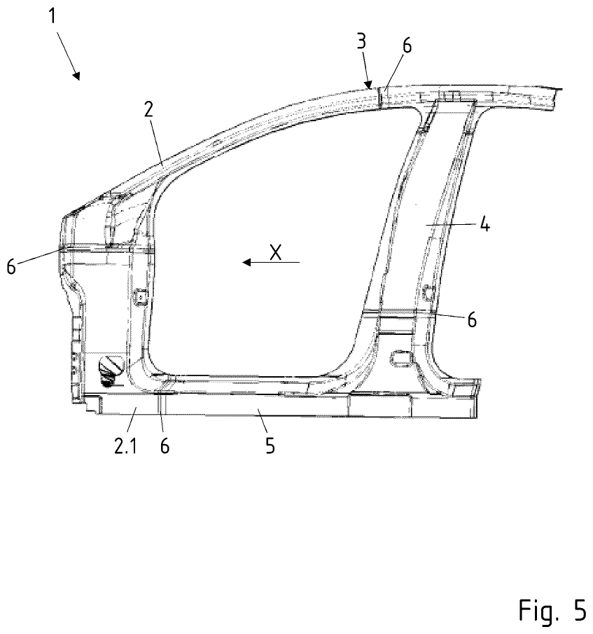

FIG. 5 shows a further embodiment of a door ring 1 according to the present disclosure. Here, respective transition regions 6 or connection regions between two components are shown. The vehicle sill 5 extends here over a large part in the vehicle X direction and is connected to an A-pillar 2 in the front region. This results in a small A-pillar stub 2.1, the B-pillar 4 is formed directly with the lower base region by the sill 5 and is then coupled above the B-pillar base. The B-pillar 4 includes an upper T-piece in the region of the roof frame 3. This is also able to be referred to as a roof frame stub on B-pillar 4. This is then coupled to the A-pillar 2 in a connection region 6.

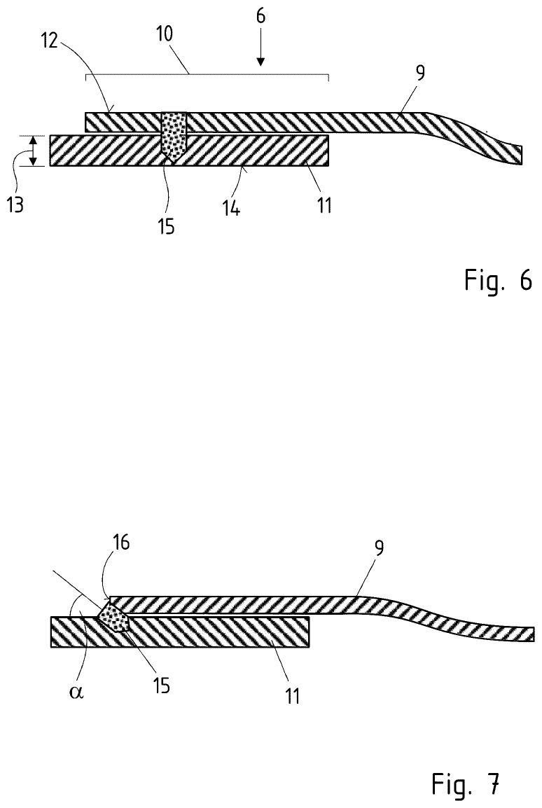

FIG. 6 now shows a connection region 6 in cross-sectional view. An upper layer 9 or first layer of a component overlaps in an overlap region 10 a lower layer 11 or second layer of a second component. The overlap region 10 has an extension transverse to the image plane of less than 25 mm. A weld seam 15 or weld root is introduced from an upper side 12 of the upper layer 9, and extends with a depth of 13 into the second layer while completely penetrating the first or upper layer 9. In the lower layer 11, however, said component penetrates the second layer by less than 95%, or less than 90%. This offers the advantage that a surface coating on the underside 14 of the lower layer 11 is not affected by a burn-through of the weld seam 15 and that aluminum from the coating of the underside 14 does not mix with the weld pool during welding. The corrosion protection layer on the lower side of the layer is then completely preserved. In at least one embodiment of the present disclosure, this possibility, according to which the weld seam 15 or weld root is formed substantially perpendicular to the surface of the layers, offers the possibility of forming not only a linear weld seam 15, but a weld seam 15, the longitudinal course of which is formed, for example, in a wave-shape, zigzag-shape or even according to a saw tooth profile.

The respective corrosion protection layer is not shown in detail here, but is also formed in the overlap region 10 between the layers 11, 17, so that the overlap region 10 is also protected against corrosion.

FIG. 7 shows a further embodiment of the weld seam 15 produced according to the present disclosure by means of laser welding. The weld seam 15 is introduced obliquely here. In at least one embodiment of the present disclosure, with an angle α, which is in the range of 30° to 45°, of a respective surface of the layers 11, 17 to each other. This results in the advantage that the weld seam 15 is introduced from a front edge 16 of the upper layer. The front edge 16 is also able to be referred to as the cutting edge. Any corrosion protection layer is initially only formed to a reduced extent or not at all on this front edge 16. No corrosion protection layer is introduced into the weld seam 15 itself, which further improves the quality of the weld seam 15 and thus the strength to be achieved.

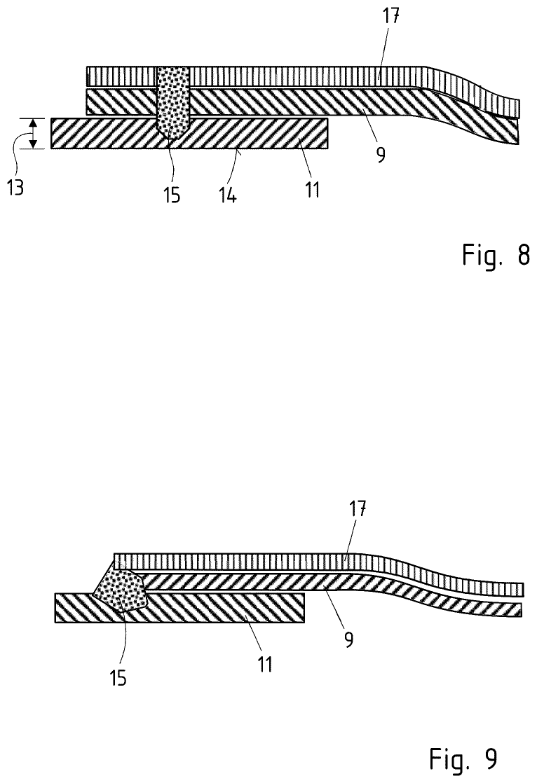

FIG. 8 shows a further embodiment variant according to the present disclosure. Here, a triple layer is formed, not a double layer as shown in FIG. 6 and FIG. 7. A further layer 17, for example, a reinforcement patch or similar, is arranged in this case. The lowest layer 11 shown on the image plane is in turn penetrated by the weld seam 15 to a depth of less than 95%, or less than 90%. A surface coating on the lower side is therefore not damaged by the weld seam 15.

Analogous arguments to FIG. 7 also apply to FIG. 9. Here, the weld seam 15 is introduced obliquely to the surface and connects the three layers together.

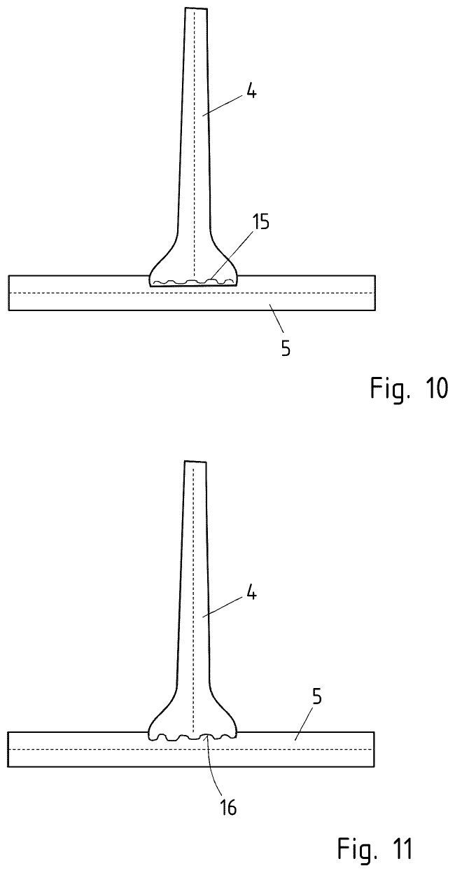

FIG. 10 shows an example of a weld seam profile in its longitudinal direction. This is designed according to a waveform. In this case, a B-pillar 4 or a B-pillar base is connected to a sill 5. The weld seam 15 is introduced according to the functional principle in the cross section according to FIG. 6 and is able to have a wave-shaped course. This increases the length and thus also the effective cross-sectional region of the weld seam, which advantageously also results in a reduced local stress concentration in the event of crash-related or mechanical stresses.

FIG. 11 shows a corresponding alternative embodiment variant. Here, a front edge 16 of the B-pillar base is shown on the lower side 14. Even this has a wave-like course. The weld seam 15 is designed according to the functional principle in cross section according to FIG. 7.

The steel grades used are able to be used as examples below and are able to be used for all variants of present disclosure. In at least one embodiment of the present disclosure, different types of steel are able to be combined in a Tailored Welded Blank. The corresponding strength ranges for hard or soft zones or solid or ductile regions are able to be found in the table. All alloy components are given in wt. %, wherein the respective hardenable steel alloy then contains the remaining iron and impurities resulting from the melting process.

The foregoing description of some embodiments of the disclosure has been presented for purposes of illustration and description. The description is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. Various changes, substitutions and alterations can be made hereto without departing from the spirit and scope of the disclosure.

| | C | | Si | | Mn | | P | S | Al | | B | | Cr |
|---|---|---|---|---|---|---|---|---|---|---|---|---|---|
| | min | max | min | max | min | max | max | max | min | max | min | max | min |
| Steel A | 0.19 | 0.25 | 0.1 | 0.4 | 1.1 | 1.4 | 0.02 | 0.005 | 0 | 0.06 | 0.004 | 0.1 | |
| Steel B | 0.2 | 0.23 | 0.2 | 0.3 | 1.1 | 1.4 | 0.02 | 0.005 | 0 | 0.06 | 0.004 | 0.1 | 0.1 |
| Steel C | 0.31 | 0.37 | 0.1 | 0.6 | 1 | 1.5 | 0.025 | 0.02 | | 0.1 | 0.001 | 0.004 | 0.08 |
| Steel D | 0.33 | 0.35 | 0.15 | 0.35 | 1 | 1.5 | 0.025 | 0.015 | 0.01 | 0.08 | 0.001 | 0.004 | 0.08 |
| Steel E | 0.06 | 0.13 | | 0.7 | | 1.9 | 0.05 | 0.05 | | 0.1 | | 0.003 | |
| Steel F | 0.07 | 0.11 | 0.02 | 0.6 | 1.2 | 1.8 | 0.03 | 0.01 | 0.01 | 0.07 | 0.0007 | 0.002 | |

| | | Cu | N | Nb | | Ni | | Ti | | V | Mo |
|---|---|---|---|---|---|---|---|---|---|---|---|
| | max | max | max | min | max | min | max | min | max | max | max |
| Steel A | 0.3 | 0.1 | | | 0.05-Ti | 0.02 | 0.1 | 0.01 | 0.1 | | 0.35 |
| Steel B | 0.3 | 0.1 | 0.01 | | 0.05-Ti | 0.02 | 0.1 | 0.02 | 0.05 | 0.01 | 0.35 |
| Steel C | 0.35 | 0.2 | 0.2 | | 0.1 | | 0.2 | 0.002 | 0.05 | | 0.35 |
| Steel D | 0.5-Mo | 0.2 | 0.2 | 0.01 | 0.06 | | 0.2 | 0.005 | 0.015 | 0.01 | 0.5-Cr |
| Steel E | 0.15 | 0.2 | 0.2 | | 0.1 | | | | 1.2 | 0.1 | 0.1 |
| Steel F | 0.15 | 0.2 | 0.2 | 0.04 | 0.1 | | | 0.03 | 0.2 | 0.1 | 0.1 |

1-12. (canceled)

13. A door ring for a motor vehicle body, comprising:
a plurality of individual components comprising an A-pillar, a B-pillar, a roof frame part and a sill part, the plurality of individual components coupled together,
wherein
the door ring includes a first region that has a tensile strength Rm greater than 1300 MPa, and a second region that has a tensile strength Rm less than 1000 MPa,
the door ring has a corrosion protection layer,
among the plurality of components, a first component and a second component comprise two different steel grades, respectively,
in an overlap region, the first component and the second component overlap each other and are laser-welded together at a weld seam, and
the corrosion protection layer is between the first component and the second component in the overlap region.

14. The door ring according to claim 13, wherein at least one of the first and second components of the door ring is a hot-formed and press-hardened component.

15. The door ring according to claim 13, wherein the first region has a tensile strength greater than or equal to 1800 MPa.

16. The door ring according to claim 13, wherein the second region has at least one of:
a tensile strength Rm less than 850 MPa, or a smaller wall thickness compared to a wall thickness of the first region.

17. The door ring according to claim 13, wherein the corrosion protection layer comprises AlSiFe.

18. The door ring according to claim 13, wherein the plurality of individual components are laser-welded together to form the door ring.

19. The door ring according to claim 13, wherein the weld seam consists exclusively of chemical elements of the steel grades of the first and second components, and chemical elements of the corrosion protection layer.

20. The door ring according to claim 13, wherein the overlap region of the first and second components is less than 25 mm.

21. The door ring according to claim 13, wherein, in the overlap region, the weld seam comprises an oblique weld root between the first and second components.

22. The door ring according to claim 13, wherein the weld seam is introduced from edges of both of the first and second components, or a weld root of the weld seam is straight in cross section and extends perpendicular to the first and second components in the overlap region.

23. The door ring according to claim 13, wherein the weld seam comprises a weld root that penetrates less than 90% of the second component in cross section.

24. The door ring according to claim 13, wherein the weld seam of the first and second components amounts to at least 60% of a total cross-sectional length or extension length.

25. The door ring according to claim 13, wherein the first component and the second component are laser-welded together with a lap joint.

26. The door ring according to claim 13, wherein the hot-formed and press-hardened component is formed in one press stroke.

27. The door ring according to claim 13, wherein the corrosion protection layer comprises Zn.

28. The door ring according to claim 13, wherein the overlap region of the first and second components is less than 20 mm.

29. The door ring according to claim 13, wherein the overlap region of the first and second components is less than 15 mm.

30. The door ring according to claim 13, wherein the overlap region of the first and second components is less than 10 mm.

31. The door ring according to claim 13, wherein the weld seam of the first and second components amounts to at least 70% of a total cross-sectional length or extension length.

32. The door ring according to claim 13, wherein the weld seam of the first and second components amounts to at least 80% of a total cross-sectional length or extension length.
